(19) United States
(12) Patent Application Publication
(10) Pub. No.: US 2025/0005474 A1
(43) Pub. Date: Jan. 2, 2025

(54) SUSTAINABILITY AWARE ASSET INVESTMENT OPTIMIZATION

(71) Applicant: International Business Machines Corporation, Armonk, NY (US)

(72) Inventors: Pavankumar Murali, Ardsley, NY (US); Nianjun Zhou, Chappaqua, NY (US); Anuradha Bhamidipaty, Yorktown Heights, NY (US); Dzung Tien Phan, Pleasantville, NY (US); Carlos M. Ferreira, London (GB); Krishnamohan Dantam, Chelmsford, MA (US)

(21) Appl. No.: 18/343,978

(22) Filed: Jun. 29, 2023

(51) Int. Cl. G06Q 10/0631; G06Q 10/0635; G06Q 10/0639

(52) U.S. Cl. CPC G06Q 10/06313; G06Q 10/0635; G06Q 10/0639

(57) ABSTRACT

A computer implemented method for estimating environmental impact for industrial assets is provided. A number of processor units receive data for an industrial asset. The data for the industrial asset includes a number of variables associated with sustainability of the industrial asset. The sustainability of the industrial asset includes energy consumption, leakage, and energy loss associated with operations for the industrial asset. The number of processor units determines a relationship between environmental impact for the industrial asset and the number of variables according to the data. The number of processor units forecast energy consumption, leakage, and energy loss over a period of time for the industrial asset based on the data. The number of processor units estimate environmental impact for the industrial asset over the period of time based on the forecasted energy consumption, the forecasted energy loss, forecasted leakage, and the relationship.

### BACKGROUND

The disclosure relates generally to an improved computer system and more specifically to a computer implemented method, apparatus, system, and computer program product for asset optimization based on estimating environmental impact for the asset.

Energy emissions have significant environmental impacts on climate change. The release of greenhouse gases such as carbon dioxide, methane, and nitrous oxide are major contributors to global warming. These greenhouse gases trap heat in the Earth's atmosphere that leads to rising temperatures and altered weather patterns. The environmental impact of energy emissions also has significant implications for companies regarding operational costs and sustainability efforts. As depicted, the greenhouse gas emissions contribute to climate change and environmental degradation. As a result, companies such as manufacturers face increasing pressure to reduce their carbon footprint and minimize their impact on the environment.

### SUMMARY

According to one illustrative embodiment, a computer implemented method for estimating environmental impact for industrial assets is provided. A number of processor units receive data for an industrial asset. The data for the industrial asset includes a number of variables associated with sustainability of the industrial asset. The sustainability of the industrial asset includes energy consumption, leakage, and energy loss associated with operations for the industrial asset. The number of processor units determines a relationship between environmental impact for the industrial asset and the number of variables according to the data. The number of processor units forecast energy consumption, leakage, and energy loss over a period of time for the industrial asset based on the data. The number of processor units estimate environmental impact for the industrial asset over the period of time based on the forecasted energy consumption, the forecasted energy loss, forecasted leakage, and the relationship.

According to other illustrative embodiments, a computer system, and a computer program product for estimating environmental impact for industrial assets is provided. As a result, the illustrative embodiments estimate environmental impact for an industrial asset using a relationship between variables associated with sustainability of the industrial asset and environmental impact that can be caused by the industrial asset.

The illustrative embodiments can permissively generate a multi-dimensional risk matrix based on criticality, risk of failure and estimated environmental emission for the industrial asset, using estimated environmental impact, to show risk of repairment and replacement for the industrial asset. The multi-dimensional risk matrix can be displayed to show a number of industrial assets with levels of risk in different colors. As a result, the illustrative embodiments can provide a technical effect of obtaining an improving display to efficiently identify industrial assets that need immediate attention.

The illustrative embodiments can permissively determine costs associated with the industrial asset based on estimated environmental impact for the industrial asset over the period of time and generate an objective function to minimize costs associated with the industrial asset. The objective function can be used to generate a management plan to repair and replace the industrial asset. As a result, the illustrative embodiments can provide a technical effect of obtaining an improved optimization solution for scheduling repair and replacement for the industrial asset.

### BRIEF DESCRIPTION OF THE DRAWINGS

FIG. 1 is a block diagram of a computing environment in accordance with an illustrative embodiment;

FIG. 2 is a block diagram of an asset optimization environment in accordance with an illustrative embodiment;

FIG. 3 is a risk matrix in accordance with an illustrative embodiment;

FIG. 4 is a plot for determining management plan using objective function in accordance with an illustrative embodiment;

FIG. 5 is a flowchart of a process for estimating environmental impact for an industrial asset in accordance with an illustrative embodiment;

FIG. 6 is a flowchart of a process for generating a multi-dimensional risk matrix in accordance with an illustrative embodiment;

FIG. 7 is a flowchart of a process for generating a management plan in accordance with an illustrative embodiment;

FIG. 8 is a block diagram of a data processing system in accordance with an illustrative embodiment.

### DETAILED DESCRIPTION

According to one illustrative embodiment, a computer implemented method for estimating environmental impact for industrial assets is provided. A number of processor units receive data for an industrial asset. The data for the industrial asset includes a number of variables associated with sustainability of the industrial asset. The sustainability of the industrial asset includes energy consumption, leakage, and energy loss associated with operations for the industrial asset. The number of processor units determines a relationship between environmental impact for the industrial asset and the number of variables according to the data. The number of processor units forecast energy consumption, leakage, and energy loss over a period of time for the industrial asset based on the data. The number of processor units estimate environmental impact for the industrial asset over the period of time based on the forecasted energy consumption, the forecasted energy loss, forecasted leakage, and the relationship. As a result, the illustrative embodiments provide a technical effect of producing accurate environmental impact estimation for industrial assets by considering sustainability of the industrial assets.

As part of estimating, by the number of processor units, environmental impact for industrial asset, the environmental impact for the computer implemented method includes at least one of noise, air pollution, water pollution, environmental emission, solid wastes, radiation, or fire hazard. As a result, the illustrative embodiments provide a technical effect of producing accurate environmental impact estimation by considering different types of environmental impact.

The number of processor units further generates a multi-dimensional risk matrix based on estimated environmental emission, risk of failure, and criticality of industrial assets for the industrial asset. As a result, the illustrative embodiments provide a technical effect of producing an efficient method to store information associated with risk for industrial assets.

As part of generating, by the number of processor units, the multi-dimensional risk matrix, the number of processor units display the multi-dimensional risk matrix. Each element in the multi-dimensional risk matrix includes a number of industrial assets that correspond to a level of risk for the number of industrial assets based on estimated environmental emission, risk of failure, and criticality for the number of industrial assets. As a result, the illustrative embodiments provide a technical effect of presenting industrial assets with different levels of risk for efficient identification of industrial assets.

The number of processor units further determines costs associated with the industrial asset based on estimated environmental impact for the industrial asset over the period of time. As a result, the illustrative embodiments provide a technical effect of determining costs associated with industrial assets by considering environmental impact caused by the industrial assets.

As part of determining, by the number of processor units, costs associated with the industrial asset, the processor units further generate an objective function to minimize costs associated with the industrial asset. The processor units generate a management plan for the industrial asset using the objective function. As a result, the illustrative embodiments provide a technical effect of determining a cost-efficient approach to manage industrial assets by considering environmental impact caused by the industrial assets.

As part of generating, by the number of processor units, the management plan for the industrial asset using the objective function, the management plan includes at least one of replacing the industrial asset at a time point within the period of time and repairing the industrial asset at a time point within the period of time. As a result, the illustrative embodiments provide a technical effect of generating management plan for the industrial assets by replacing the industrial asset at a time point within the period of time or repairing the industrial asset at a time point within the period of time.

According to one illustrative embodiment, a computer system for estimating environmental impact for industrial assets is provided. The computer system includes a number of processor units to execute program instructions to receive data for an industrial asset. The data for the industrial asset includes a number of variables associated with sustainability of the industrial asset. The sustainability of the industrial asset includes energy consumption, leakage, and energy loss associated with operations for the industrial asset. The number of processor units execute program instructions to determine a relationship between environmental impact for the industrial asset and the number of variables according to the data. The number of processor units execute program instructions to forecast energy consumption, leakage, and energy loss over a period of time for the industrial asset based on the data. The number of processor units execute program instructions to estimate environmental impact for the industrial asset over the period of time based on the forecasted energy consumption, the forecasted energy loss, forecasted leakage, and the relationship. As a result, the illustrative embodiments provide a technical effect of producing accurate environmental impact estimation for industrial assets by considering sustainability of the industrial assets.

As part of estimating environmental impact for industrial asset, the environmental impact for the computer system includes at least one of noise, air pollution, water pollution, environmental emission, solid wastes, radiation, or fire hazard. As a result, the illustrative embodiments provide a technical effect of producing accurate environmental impact estimation by considering different types of environmental impact.

The number of processor units execute program instructions to generate a multi-dimensional risk matrix based on estimated environmental emission, risk of failure, and criticality of industrial assets for the industrial asset. As a result, the illustrative embodiments provide a technical effect of producing an efficient method to store information associated with risk for industrial assets.

As part of generating the multi-dimensional risk matrix, the number of processor units execute program instructions to display the multi-dimensional risk matrix. Each element in the multi-dimensional risk matrix includes a number of industrial assets that correspond to a level of risk for the number of industrial assets based on estimated environmental emission, risk of failure, and criticality for the number of industrial assets. As a result, the illustrative embodiments provide a technical effect of presenting industrial assets with different levels of risk for efficient identification of industrial assets.

The number of processor units execute program instructions to determine costs associated with the industrial asset based on estimated environmental impact for the industrial asset over the period of time. As a result, the illustrative embodiments provide a technical effect of determining costs associated with industrial assets by considering environmental impact caused by the industrial assets.

As part of determining costs associated with the industrial asset, the number of processor units execute program instructions to generate an objective function to minimize costs associated with the industrial asset. The number of processor units execute program instructions to a management plan for the industrial asset using the objective function. As a result, the illustrative embodiments provide a technical effect of determining a cost-efficient approach to manage industrial assets by considering environmental impact caused by the industrial assets.

As part of generating the management plan for the industrial asset using the objective function, the management plan includes at least one of replacing the industrial asset at a time point within the period of time or repairing the industrial asset at a time point within the period of time. As a result, the illustrative embodiments provide a technical effect of generating management plan for the industrial assets by replacing the industrial asset at a time point within the period of time and repairing the industrial asset at a time point within the period of time.

According to one illustrative embodiment, a computer program product for estimating environmental impact for industrial assets is provided. The computer program product includes a computer readable storage medium having program instructions embodied therewith. The program instructions executable by a computer system to cause the computer system to receive data for an industrial asset. The data for the industrial asset includes a number of variables associated with sustainability of the industrial asset. The sustainability of the industrial asset includes energy consumption, leakage, and energy loss associated with operations for the industrial asset. The program instructions executable by a computer system to cause the computer system to determine a relationship between environmental impact for the industrial asset and the number of variables according to the data. The program instructions executable by a computer system to cause the computer system to forecast energy consumption, leakage, and energy loss over a period of time for the industrial asset based on the data. The program instructions executable by a computer system to cause the computer system to estimate environmental impact for the industrial asset over the period of time based on the forecasted energy consumption, the forecasted energy loss, forecasted leakage, and the relationship. As a result, the illustrative embodiments provide a technical effect of producing accurate environmental impact estimation for industrial assets by considering sustainability of the industrial assets.

As part of estimating environmental impact for industrial asset, the environmental impact for the computer program product includes at least one of noise, air pollution, water pollution, environmental emission, solid wastes, radiation, or fire hazard. As a result, the illustrative embodiments provide a technical effect of producing accurate environmental impact estimation by considering different types of environmental impact.

The program instructions executable by a computer system to further cause the computer system to generate a multi-dimensional risk matrix based on estimated environmental emission, risk of failure, and criticality of industrial assets for the industrial asset. As a result, the illustrative embodiments provide a technical effect of producing an efficient method to store information associated with risk for industrial assets.

As part of generating the multi-dimensional risk matrix, the program instructions executable by a computer system to further cause the computer system to display the multi-dimensional risk matrix. Each element in the multi-dimensional risk matrix includes a number of industrial assets that correspond to a level of risk for the number of industrial assets based on estimated environmental emission, risk of failure, and criticality for the number of industrial assets. As a result, the illustrative embodiments provide a technical effect of presenting industrial assets with different levels of risk for efficient identification of industrial assets.

The program instructions executable by a computer system to further cause the computer system to determine costs associated with the industrial asset based on estimated environmental impact for the industrial asset over the period of time. As a result, the illustrative embodiments provide a technical effect of determining costs associated with industrial assets by considering environmental impact caused by the industrial assets.

As part of determining costs associated with the industrial asset, the program instructions executable by a computer system to further cause the computer system to generate an objective function to minimize costs associated with the industrial asset. The program instructions executable by a computer system to cause the computer system to a management plan for the industrial asset using the objective function. As a result, the illustrative embodiments provide a technical effect of determining a cost-efficient approach to manage industrial assets by considering environmental impact caused by the industrial assets.

As part of generating a management plan for the industrial asset using the objective function, the management plan includes at least one of replacing the industrial asset at a time point within the period of time or repairing the industrial asset at a time point within the period of time. As a result, the illustrative embodiments provide a technical effect of generating management plan for the industrial assets by replacing the industrial asset at a time point within the period of time and repairing the industrial asset at a time point within the period of time.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals Beltway flight leg late of the very thing you is now the well he is the 50 and that was the end of their label 5 communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

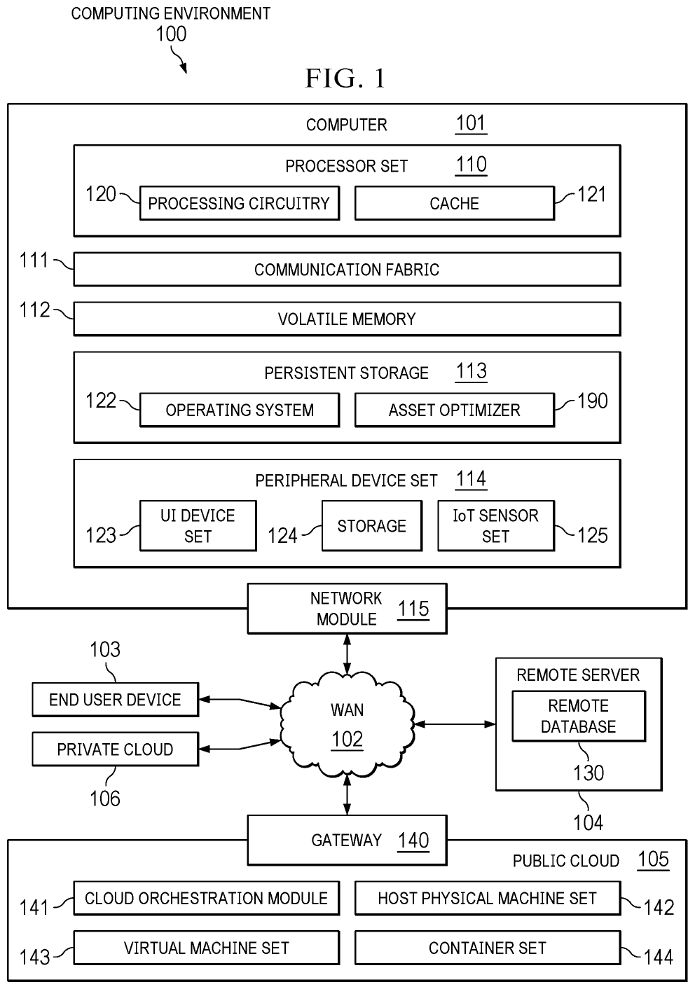

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as asset optimizer 190. In this example, asset optimizer 190 can operate to manage at least one of the creation or optimization of machine learning models. In the different illustrative examples, asset optimizer 190 can operate to apply regression models into an optimization process for data driven model optimization.

In addition to asset optimizer 190, computing environment 100 includes, for example, computer 101, wide area network (WAN) 102; end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and asset optimizer 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in asset optimizer 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in asset optimizer 190 includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrative embodiments recognize and take into account a number of different considerations as described herein. For example, the illustrative embodiments recognize and take into account that sustainability such as environmental, economic, and social impacts are becoming critical in order to meet zero emissions targets set by 2030 Pairs Accord.

One of the major challenges that companies face is balancing the cost of energy consumption. Traditional energy sources are cost-effective but have higher carbon emissions, while renewable energy helps to reduce emissions but involve higher costs.

Companies are adopting different strategies to address this challenge. Those strategies include implementing energy-efficient technologies, optimizing energy consumption using monitor systems and control systems, and investing in renewable energy sources. In addition, companies are increasingly considering the lifecycle of assets and how to best utilize the assets to maximize efficiency when making minimal environmental impacts.

Making decisions regarding asset repair and replacement requires careful consideration of various factors. Maintenance and repair activities aim to extend the asset's lifespan and ensure optimal operations, while replacement decisions involve determining when the costs of continued repair outweigh the benefits. In this example, the decision-making process for asset repair and replacement involves balancing short-term costs with long-term benefits to optimize asset performance, minimize downtime, and maximize the return on investment.

Optimization models can be a valuable approach to make decisions for asset repair and replacement. By considering factors such as asset condition, asset performance, maintenance costs, and downtime, optimization models can generate insights on how to allocate resources for repairs and replacements. For example, the optimization model can incorporate variables such as asset criticality, expected lifespan, budget constraints, and the availability of alternative assets. By quantifying these variables, companies can make decisions that balance between repair costs, replacement costs, and asset performance for maximizing usage of assets. However, optimization models may not provide a desired level of accuracy if not used properly.

Additionally, the illustrative embodiments recognize and take into account that assets repair and replacement decisions are currently determined only based on failure risk and criticality of the assets. In other words, sustainability of industrial assets is not considered when making repair and replacement decisions for the industrial assets. As a result, the current decision for repairing and replacing industrial assets is not desirable because of a lack of confidence regarding the environmental impacts caused by the industrial assets when making decisions to repair and replace the industrial assets.

The illustrative embodiments recognize and take account that an improved visualization should be generated for efficiently identifying industrial assets that need attention to repair and replace. The illustrative examples provide a computer implemented method, apparatus, computer system, and computer program product for estimating environmental impacts for generating a management plan to repair and replace industrial assets with minimal costs.

In an illustrative example, data associated with sustainability of an industrial asset is received, and a relationship between environmental impact for an industrial asset and variables associated with operations, maintenance and technical specifications of the industrial asset is determined. Energy consumption, leakage, and energy loss for industrial assets are forecasted over a period of time. The forecasted energy consumption, leakage, and energy loss for industrial assets is used with the relationship to estimate environmental impact caused by the industrial asset over the period of time.

In another illustrative example, estimated environmental impact can be used to generate a risk matrix that includes elements that represent levels of risk for industrial assets. In yet another illustrative example, elements in the risk matrix have different colors to indicate different levels of risk for industrial assets.

In yet another illustrative example, costs associated with the industrial asset are determined based on estimated environmental impact. The costs can be used with an objective function to generate a management plan for the industrial asset. In yet another illustrative example, the management plan includes replacing and repairing the industrial asset at a time point within the period of time.

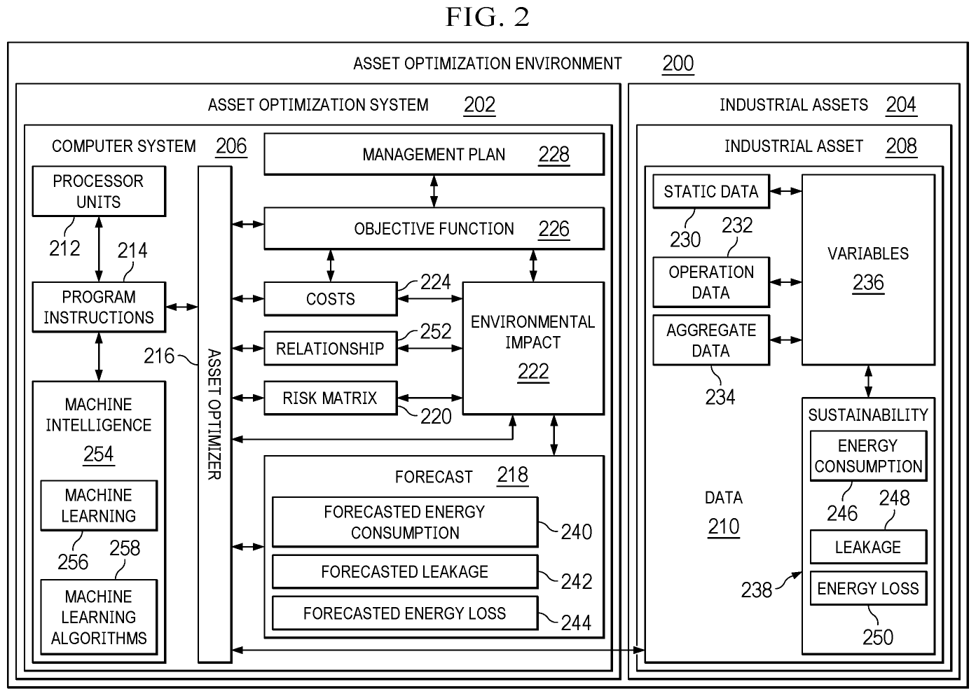

With reference now to FIG. 2, a block diagram of an asset optimization environment is depicted in accordance with an illustrative embodiment. In this illustrative example, asset optimization environment 200 includes components that can be implemented in computing environment 100 in FIG. 1.

In this illustrative example, asset optimization system 202 in asset optimization environment 200 can be used to determine environmental impact 222 for industrial asset 208. This environmental impact can be used to manage at least one of a process or a system.

Asset optimization system 202 comprises a number of different components. As depicted, asset optimization system 202 comprises computer system 206 and asset optimizer 216. Asset optimizer 216 is located in computer system 206.

Asset optimizer 216 can be implemented in software, hardware, firmware, or a combination thereof. When software is used, the operations performed by asset optimizer 216 can be implemented in program instructions configured to run on hardware, such as a processor unit. When firmware is used, the operations performed by asset optimizer 216 can be implemented in program instructions and data and stored in persistent memory to run on a processor unit. When hardware is employed, the hardware can include circuits that operate to perform the operations in asset optimizer 216.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 206 is a physical hardware system and includes one or more data processing systems. When more than one data processing system is present in computer system 206, those data processing systems are in communication with each other using a communications medium. The communications medium can be a network. The data processing systems can be selected from at least one of a computer, a server computer, a tablet computer, or some other suitable data processing system.

As depicted, computer system 206 includes a number of processor units 212 that are capable of executing program instructions 214 implementing processes in the illustrative examples. In other words, program instructions 214 are computer readable program instructions.

As used herein, a processor unit in the number of processor units 212 is a hardware device and is comprised of hardware circuits such as those on an integrated circuit that respond to and process instructions and program instructions that operate a computer. A processor unit can be implemented using processor set 110 in FIG. 1. When the number of processor units 212 executes program instructions 214 for a process, the number of processor units 212 can be one or more processor units that are in the same computer or in different computers. In other words, the process can be distributed between processor units 212 on the same or different computers in computer system 206.

Further, the number of processor units 212 can be of the same type or different type of processor units. For example, the number of processor units 212 can be selected from at least one of a single core processor, a dual-core processor, a multi-processor core, a general-purpose central processing unit (CPU), a graphics processing unit (GPU), a digital signal processor (DSP), or some other type of processor unit.

Computer system 206 further includes machine intelligence 254. Machine intelligence 254 comprises machine learning 256 and machine learning algorithms 258. Machine learning 256 is a branch of artificial intelligence (AI) that enables computers to detect patterns and improve performance without direct programming commands. Rather than relying on direct input commands to complete a task, machine learning 256 relies on input-data. The data is fed into the machine, one of machine learning algorithms 258 is selected, parameters for the data are configured, and the machine is instructed to find patterns in the input data through optimization algorithms. The data model formed from analyzing the data is then used to predict future values. In this illustrative example, the learning of the asset optimizer 216 can be achieved through a database input that is continuously refined over time through trial and error. Equivalence of assets or products can be effectively performed by supervised machine learning so that products or assets that do not match descriptively can nevertheless be matched. Over time, the data model from machine learning can provide a greater degree of flexibility in matching for the asset optimizer 216.

Machine intelligence 254 can be implemented using one or more systems such as an artificial intelligence system, a neural network, a Bayesian network, an expert system, a fuzzy logic system, a genetic algorithm, or other suitable types of systems. Machine learning 256 and machine learning algorithms 258 may make computer system 206 a special purpose computer for dynamic predictive modelling for processing data records.

Machine learning 256 involves using machine learning algorithms 258 to build machine learning models based on samples of data. The samples of data used for training referred to as training data or training datasets. Machine learning models trained using training datasets and make predictions without being explicitly programmed to make these predictions. Machine learning models can be trained and retrained for a number of different types of applications. These applications include, for example, medicine, healthcare, speech recognition, computer vision, or other types of applications. In this example, the outputs from machine learning model can be used to retrain the machine learning algorithm 258 to make better predictions and forecasts.

Machine learning algorithms 258 can include supervised machine learning algorithms and unsupervised machine learning algorithms. Supervised machine learning can train machine learning models using data containing both the inputs and desired outputs. Examples of machine learning algorithms include XGBoost, K-means clustering, and random forest.

In this illustrative example, asset optimizer 216 receives data 210 for industrial asset 208. Industrial asset 208 is one industrial asset in industrial assets 204. In this example, industrial assets such as industrial assets 204 are physical equipment that are designed to perform certain industrial functions in various industries. For example, industrial assets 204 can be machinery, vehicles, medical equipment, switchgear, and transformers.

Data 210 is obtained from industrial asset 208 during operation of industrial asset 208. In this example, data 210 includes different types of data for industrial asset 208. Data 210 includes static data 230, operation data 232, and aggregate data 234 for industrial asset 208. Static data 230 is static data that does not change over time. For example, static data 230 can include asset type, effective age, output rating, fuel type, and network criticality for industrial asset 208. In this example, network criticality is the importance of industrial asset 208 in industrial assets 204.

Operation data 232 is dynamic data that is obtained during operation of industrial asset 208. For example, operation data 232 includes usage, weather pattern, leakage, noise, vibration, and energy loss during operation of industrial asset 208. In this example, operation data 232 can be obtained periodically. For example, operation data 232 can be obtained every day, every week, every month, or any suitable time interval.

Further, aggregate data 234 are data associated with impact that industrial asset 208 has for industrial assets 204. For example, aggregate data 234 includes how much industrial asset 208 contributes to the productivity of industrial assets 204, costs for replacing and repairing industrial asset 208 in industrial assets 204, and how much industrial asset 208 contributes to the transportation of industrial assets 204 between different sites such as manufacturing site, installation site, or disposal site.

In this illustrative example, static data 230, operation data 232, and aggregate data 234 are used to determine variables 236. Variables 236 are associated with sustainability 238 for industrial asset 208. Sustainability 238 are metrics that can be used to evaluate industrial asset 208 regarding its impact on the environment throughout its lifecycle.

Sustainability 238 includes energy consumption 246, leakage 248, and energy loss 250. In this example, energy consumption 246 refers to the amount of energy industrial asset 208 consumes. Leakage 248 refers to unintended escape or loss of substances caused by industrial asset 208. For example, leakage 248 can be gas leakage, chemical leakage, dielectric leakage, and oil leakage. Further, energy loss 250 refers to the amount of energy that is wasted during the operation of industrial asset 208.

In other words, variables 236 are types of data from static data 230, operation data 232, and aggregate data 234 that are associated with metrics in sustainability 238. In this example, asset optimizer 216 can use machine learning models in machine intelligence 254 by inputting variables 236 and data 210 to determine relationship 252. Relationship 252 is a relationship between variables 236 and environmental impact caused by industrial asset 208.

For example, transformers are important assets in power systems that contribute to greenhouse gas emissions. Transformers incur a certain amount of electrical power losses in operation because of copper losses. Copper losses refers to the energy dissipated as heat in copper windings for a transformer due to the electrical resistance of the copper conductors. In this example, the relationship between energy loss and copper loss of transformer can be expressed in following equation:

$${V}_{k} ( t ) = {{T}_{v} ( {( 1 + {r}_{max} )}^{t - 1} / {P}_{max} / {P}_{r} )}^{2} {P}_{k} \qquad ( 1 )$$

Where Vₖ(t) is energy loss over a time period t. Ty is the time period of maximum loss, rₘₐₓ is the load growth factor, Pₘₐₓ is maximum power consumed at any time during a year, Pᵣ is rated power of a transformer, and Pₖ is amount of power loss at rated load due to resistance of winding, also called copper loss.

In this case, a transformer can be example of industrial asset 208, copper loss can be example of variables 236, greenhouse gas emissions from energy loss because of the copper loss can be example of environmental impact caused by industrial asset 208, and equation (1) can be example of relationship 252.

In this illustrative example, asset optimizer 216 generates forecast 218 based on data 210. In this illustrative example, forecast 218 includes values for energy consumption 246, leakage 248, and energy loss 250 in data 210 over a forecast period. The forecast period can be 1 month, 1 year, 10 years, or any suitable period of time. As a result, asset optimizer 216 generates forecasted energy consumption 240, forecasted leakage 242, and forecasted energy loss 244 for industrial asset 208. In this example, asset optimizer 216 can use a number of ways to generate forecast 218. For example, asset optimizer 216 can use time-series analysis, transformer models, or machine learning models from machine intelligence 254 to generate forecast 218.

In this illustrative example, asset optimizer uses forecast 218 and relationship 252 to determine environmental impact 222 for industrial asset 208. Environmental impact 222 is an estimated environmental impact caused by industrial asset 208 over the forecasted period from forecast 218. In this example, environmental impact 222 can be noise, pollution, water pollution, environmental emission, energy emission, radiation, solid wastes, and fire hazard. In an alternative example, environmental impact 222 can be monetary costs associated with noise, pollution, water pollution, environmental emission, energy emission, radiation, solid wastes, and fire hazard.

Asset optimizer 216 uses environmental impact 222 to determine costs 224 associated with industrial asset 208 over the forecasted period from forecast 218. In this example, costs 224 can be overall costs that includes cost to replace industrial asset 208, cost to repair industrial asset 208, costs from environmental impact 222 caused by industrial asset 208, and cost associated with failure of industrial asset 208.

Asset optimizer 216 generates risk matrix 220 using environmental impact 222. In this illustrative example, risk matrix 220 can be a square risk matrix that shows levels of risk for industrial asset 208. In this example, the levels of risk for an industrial asset indicates that the industrial asset involves high monetary costs. In other words, a higher level of risk for an industrial asset indicates that the industrial asset needs attention to be repaired and replaced.

In this illustrative example, risk matrix 220 can be multi-dimensional matrix that considers a number of metrics that are associated with industrial asset 208. For example, asset optimizer 216 can consider criticality and risk in addition to sustainability 238 for industrial asset 208 when generating risk matrix 220. In risk matrix 220, different metrics can be assigned with different weights when determining the level of risk for industrial asset 208.

In this illustrative example, elements with different levels of risk can be shown in different colors in risk matrix 220. For example, an element with low level of risk can be shown green, an element with moderate level of risk can be shown in yellow, and a low level of risk can be shown in red.

Further, asset optimizer 216 can generate objective function 226 for industrial asset 208. objective function 226 is a mathematical function that defines an objective that relates to an industrial asset. In this example, objective function 226 includes variables associated with the objective defined for objective function 226. For example, objective function 226 can be used to define an objective of minimizing costs associated with industrial asset 208.

For example, objective function 226 for minimizing costs associated with industrial asset 208 can be expressed as:

$${min}_{{y}_{1}} f ( {y}_{1} ) = \frac{{c}_{r} + {c}_{m} {\int }_{0}^{{y}_{1} + {y}_{0}} H ( t ) dt + {\int }_{0}^{{y}_{1} + {y}_{0}} S ( t ) dt}{{y}_{1} + {y}_{0}} \qquad ( 2 )$$

where cᵣ is the cost for replacing industrial asset 208. cₘ is the cost of maintenance as the risk of failure for industrial asset 208. cₘ increases as a function of time determined by a Weibull distribution H(t)) for industrial asset 208. Y₀ is the effective age for industrial asset 208 at the current time. S(t) is the cost associated with sustainability 238 as a function of time determined based on environmental impact 222. The objective function 226 minimizes total asset cost at replacement time y₁.

In this example, minimizing costs associated with industrial asset 208 is an example of objective for objective function. Cost for replacing industrial asset 208, cost of maintenance as the risk of failure for industrial asset 208, and cost associated with sustainability 238 are examples of variables associated with the objective defined for objective function.

Asset optimizer 216 uses objective function 226 to generate management plan 228 to replace and repair industrial asset 208. In this illustrative example, asset optimizer 216 can use objective function 226 to generate an optimization solution that includes a time point in which the costs associated with industrial asset 208 are at minimal. As a result, asset optimizer 216 can generate management plan 228 to replace and repair industrial asset 208 at an optimized time as indicated by objective function 226.

In one illustrative example, one or more solutions are present that overcome a problem with generating an optimization solution for repairing and replacing industrial assets with desired accuracy. As a result, one or more solutions provide an effect increasing the accuracy by generating the optimization solution by considering sustainability associated industrial assets. In other words, the evaluation of the optimization solution can be made based on the environmental impacts caused by industrial assets.

One or more solutions are present in which a multi-dimensional risk matrix is used to visualize industrial assets that are associated with different costs and risks. The multi-dimensional risk matrix is generated based on criticality, risk, and sustainability for industrial assets. In the multi-dimensional risk matrix, elements with different levels of risk can be shown in different colors. As a result, industrial assets that are associated with high costs and risks can be easily identified from a network of industrial assets such that immediate action can be taken.

Computer system 206 can be configured to perform at least one of the steps, operations, or actions described in the different illustrative examples using software, hardware, firmware, or a combination thereof. As a result, computer system 206 operates as a special purpose computer system in which asset optimizer 216 in computer system 206 enables performing data driven optimization to generated optimization solutions that considers sustainability for industrial assets. In particular, asset optimizer 216 transforms computer system 206 into a special purpose computer system as compared to currently available general computer systems that do not have asset optimizer 216.

The illustration of asset optimization environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, asset optimizer 216 can continue to collect data from industrial asset 208. Further, asset optimizer 216 can repeat the process of generating management plan 228 at different periods of time. This repeating of the process for generating management plan 228 can be performed to take into account situations in which changes are new to industrial asset 208 and industrial assets 204. Further, asset optimizer 216 can simultaneously generate management plans for multiple industrial assets in industrial in addition to industrial asset 208.

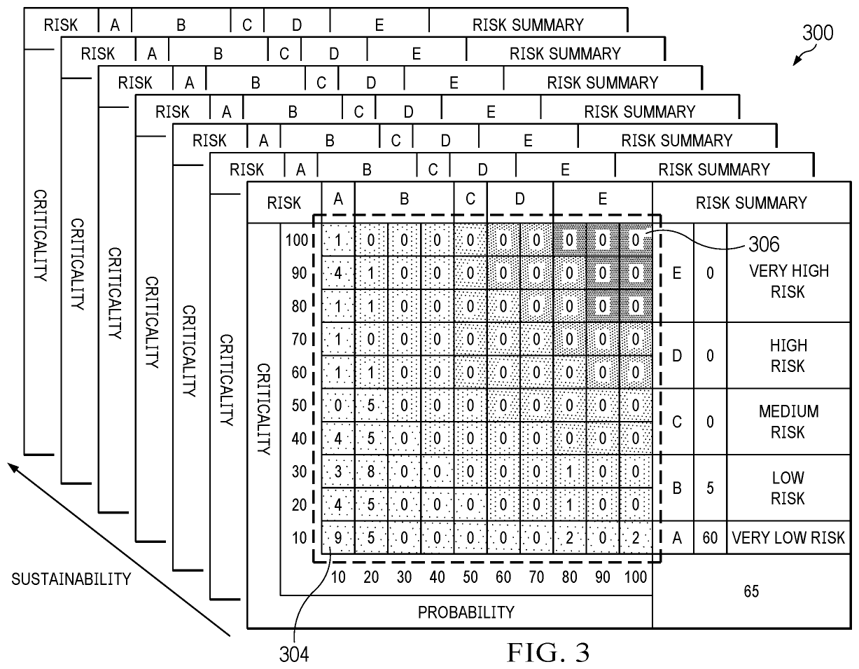

With reference now to FIG. 3, a risk matrix is depicted in accordance with an illustrative embodiment. In this illustrative example, risk matrix 300 is a two-dimensional square matrix that shows criticality and probability of failure for industrial assets. Risk matrix 300 in FIG. 3 can be an example of risk matrix 220 in FIG. 2.

As depicted, each element in risk matrix 300 has a value corresponding to the number of industrial assets associated with the level of risk represented by each element. As depicted, the level of risk of an industrial asset indicates the cost for the industrial asset. In FIG. 3, the probability of failure for industrial assets in x-axis increases from left to right, the criticality for the industrial assets in y-axis increases from bottom to top, the sustainability risk for the industrial assets in z-axis increases from shallow to deep. Further, different colors are used to represent different levels of risk. In this example, elements in a first color can correspond to very low risk, elements in a second color can correspond to low risk, elements in a third color can correspond to medium risk, elements in a fourth color can correspond to high risk, and elements in a fifth color can correspond to very high risk.

In this example, the probability of failure dimension at x-axis is presented as a quantified measure that considers a number of different metrics. For example, probability of failure dimension considers end of life (EOF) analysis, survive analysis, and failure prediction, and anomaly analysis for industrial assets. In a similar fashion, criticality dimension at y-axis is presented as a quantified measure that considers a number of different metrics. For example, criticality dimension considers household impact, grid network impact, population impact, and financial loss impact for industrial assets. Similarly, sustainability dimension at z-axis is presented as a quantified measure that considers metrics that can be used to evaluate the industrial asset regarding its impact on the environment throughout its lifecycle. For example, sustainability dimension considers environmental emission, leakage risk, noise level, disposal impact, and radiation impact.

For example, element 304 is located at bottom left corner of risk matrix 300. Element 304 includes industrial assets with lowest probability of failure, lowest sustainability risk, and lowest criticality. As a result, element 304 corresponds to a level of risk of very low risk. In this example, nine industrial assets are associated with the level of risk represented by element 304. On the other hand, element 306 is located at the top right corner of risk matrix 300. Element 306 includes industrial assets with the highest probability of failure, highest criticality, and lowest sustainability risk. As a result, element 306 corresponds to a level of risk of very high risk even though the sustainability risk is at lowest. In this example, 0 industrial assets are associated with the level of risk represented by element 306.

It should be understood that the illustrated diagram is only one embodiment of the present disclosure. The illustration of risk matrix 300 in FIG. 3 is provided as a simplified view of risk matrix for purposes of explaining features in the different illustrative examples. As depicted, risk matrix 300 is shown in three dimensions when in actuality, hundreds or thousands of dimensions can be present because of the number of variables.

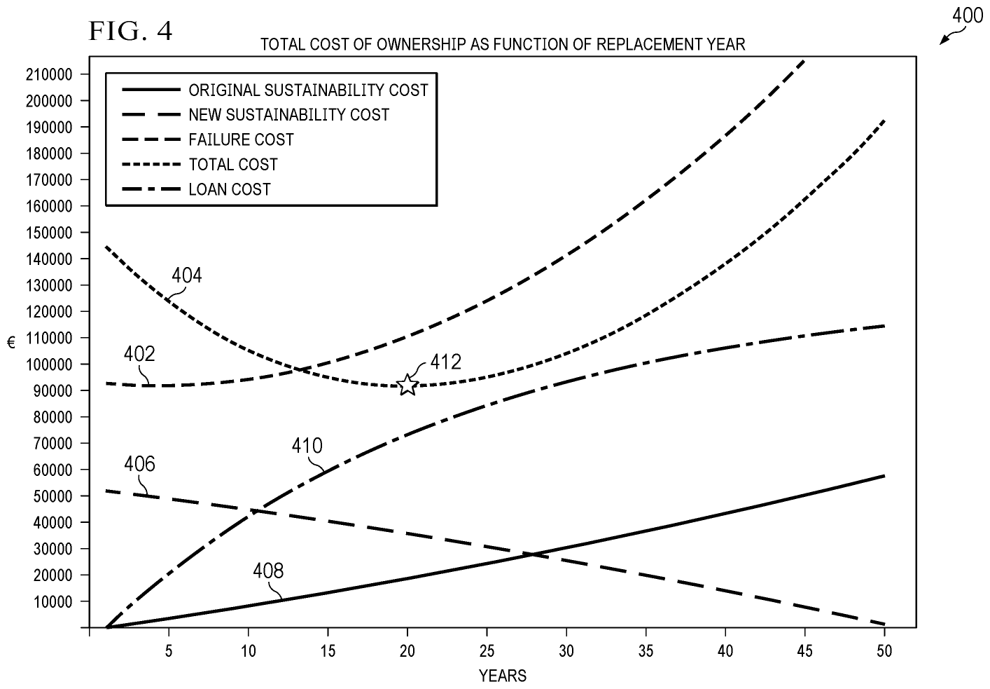

Turning now to FIG. 4, a plot for determining management plan using objective function is depicted in accordance with an illustrative embodiment. In this example, the generation of plot 400 can be implemented in asset optimization system 202 to generate management plan 228 in FIG. 2.

As depicted, plot 400 shows costs associated with an original transformer and replacement of the original transformer with a new transformer over years using different curves. In this example, the original transformer is expected to operate for 50 years. The costs for the original transformer and the new transformer are calculated using estimated environmental impact caused by the original transformer and the new transformers over time.

In FIG. 4, curve 402 shows the cost over time if the original transformer fails to operate at certain time points. Curve 406 shows the sustainability cost associated with the new transformer. Curve 408 shows the sustainability cost for the original transformers cost for the original transformer. For example, sustainability cost associated with the new transformer and the original transformer can be cost for carbon dioxide emission, noise level, and leakage of the new transformers. Curve 410 shows the cost to take a loan for investment. Further, curve 404 shows a total cost associated with the original transformer over time by combining curve 402, curve 406, curve 408, and curve 410. In this illustrative example, point 412 is identified as optimization solution generated by objective function. In other words, point 412 represents a time when the total cost for replacing the original transformer with the new transformer is lower than the cost due to higher energy losses arising from the continued use of the original transformer. As a result, a management plan for replacing the original transformer can be generated using point 412.

The illustration of plot 400 in FIG. 4 is provided as a simplified view of generating management plan for purposes of explaining features in the different illustrative examples. As depicted, plot 400 is shown in two dimensions when in actuality, hundreds or thousands of dimensions can be present because of the number of variables. In this case, the identification of optimization solution becomes more complex. As a result, the number of dimensions can be reduced in the different illustrative examples.

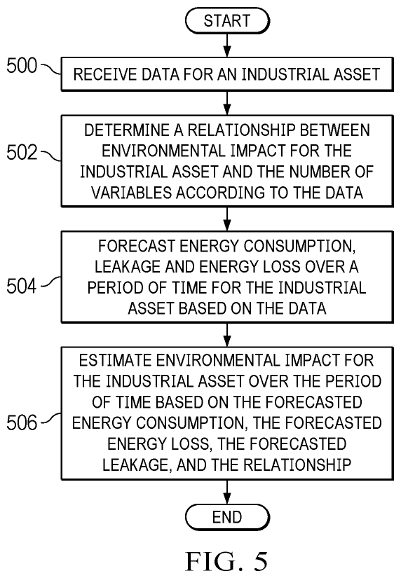

Turning next to FIG. 5, a flowchart of a process for estimating environmental impact for an industrial asset is depicted in accordance with an illustrative embodiment. The process in FIG. 5 can be implemented in hardware, software, or both. When implemented in software, the process can take the form of program instructions that are run by one of more processor units located in one or more hardware devices in one or more computer systems. For example, the process can be implemented in asset optimizer 216 in computer system 206 in FIG. 2.

The process begins by receiving data for an industrial asset (step 500). In step 500, the data for the industrial asset includes a number of variables associated with sustainability of the industrial asset. In this example, the sustainability of the industrial asset includes energy consumption leakage, energy loss, or any sustainability metric associated with operations for the industrial asset.

The process determines a relationship between environmental impact for the industrial asset and the number of variables according to the data (step 502). In this step, the environmental impact for the industrial asset can include noise pollution, water pollution, energy emission, fire hazard, or any environmental effect that can be caused by the industrial asset during operation.

The process forecasts energy consumption, leakage, and energy loss over a period of time for the industrial asset based on the data (step 504). In step 504, forecasting of energy consumption, leakage and energy loss for the industrial asset can be achieved using time-series analysis or transformer models.

The process estimates environmental impact for the industrial asset over the period of time based on the forecasted energy consumption, the forecasted energy loss, forecasted leakage, and the relationship (step 506). The process terminates thereafter.

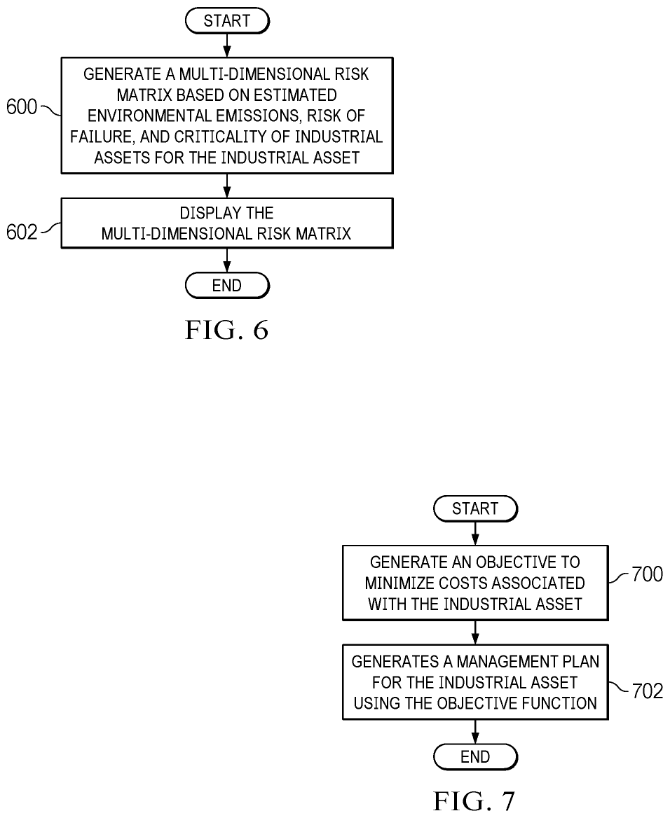

Turning next to FIG. 6, a flowchart of a process for generating a multi-dimensional risk matrix is depicted in accordance with an illustrative embodiment. The process illustrated in FIG. 6 is an example of an additional step that can be performed with the steps in FIG. 5.

The process begins by generating a multi-dimensional risk matrix based on estimated environmental emission, risk of failure, and criticality of industrial assets for the industrial asset (step 600). As depicted, the multi-dimensional risk matrix can be a square risk matrix that shows levels of risk for a number of industrial assets. In this example, the levels of risk of an industrial asset indicate the likelihood of whether the industrial asset needs to be repaired or replaced based on estimated environmental emission from estimated environmental impact, risk of the industrial asset fails, and importance of the industrial asset in the number of industrial assets. In other words, a higher level of risk for an industrial asset indicates that the industrial asset needs attention to be repaired and replaced.

The process displays the multi-dimensional risk matrix (step 602). The process terminates thereafter. In step 602, each element in the multi-dimensional risk matrix includes a number of industrial assets that correspond to a level of risk for the number of industrial assets based on estimated environmental emission, risk of failure, and criticality for the number of industrial assets. In this illustrative example, elements with different levels of risk can be shown in different colors in the multi-dimensional risk matrix. For example, an element with low level of risk can be shown green, an element with moderate level of risk can be shown in yellow, and a low level of risk can be shown in red.

Turning next to FIG. 7, a flowchart of a process for generating a management plan is depicted in accordance with an illustrative embodiment. The process illustrated in FIG. 7 is an example of an additional step that can be performed with the steps in FIG. 5.

The process begins by generating an objective to minimize costs associated with the industrial asset (step 700). In step 700, the costs associated with the industrial asset can be monetary costs associated with the operation of the industrial asset and the environmental costs for the industrial asset. For example, monetary costs associated with the operation of the industrial asset includes cost for energy consumption, cost for maintenance, and cost estimated for the downtime if the industrial asset fails. On the other hand, the environmental costs for the industrial asset can include pollution control costs from technologies installed to monitor and control emissions and disposal waste.

The process generates a management plan for the industrial asset using the objective function (step 702). The process terminates thereafter. In step 702, the management plan for the industrial asset can include a schedule for replacing the industrial asset at a time point that involves minimal cost. In an alternative illustrative example, the management plan for the industrial asset can include a schedule for repairing the industrial asset at a time point that involves minimal cost.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

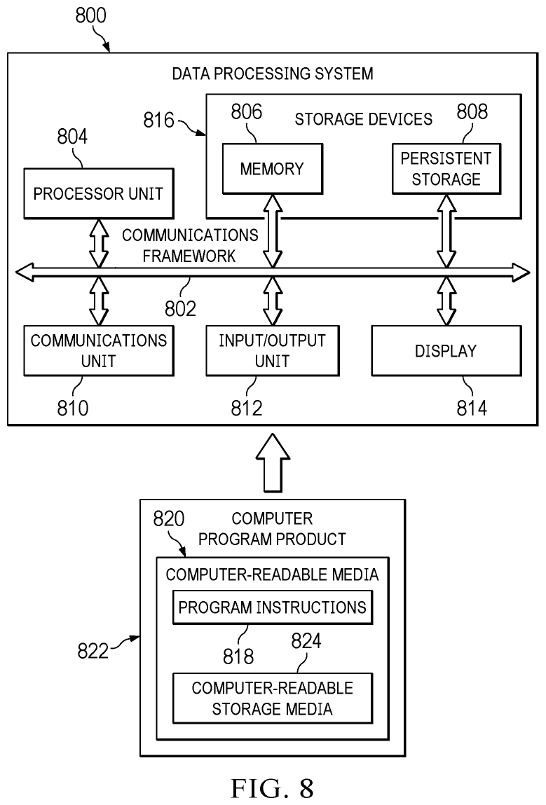

Turning now to FIG. 8, a block diagram of a data processing system is depicted in accordance with an illustrative embodiment. Data processing system 800 can be used to implement computers and computing devices in computing environment 100 in FIG. 1. Data processing system 800 can also be used to implement computer system 206 in FIG. 2. In this illustrative example, data processing system 800 includes communications framework 802, which provides communications between processor unit 804, memory 806, persistent storage 808, communications unit 810, input/output (I/O) unit 812 and display 814. In this example, communications framework 802 takes the form of a bus system.

Processor unit 804 serves to execute instructions for software that can be loaded into memory 806. Processor unit 804 includes one or more processors. For example, processor unit 804 can be selected from at least one of a multicore processor, a central processing unit (CPU), a graphics processing unit (GPU), a physics processing unit (PPU), a digital signal processor (DSP), a network processor, or some other suitable type of processor. Further, processor unit 804 can may be implemented using one or more heterogeneous processor systems in which a main processor is present with secondary processors on a single chip. As another illustrative example, processor unit 804 can be a symmetric multi-processor system containing multiple processors of the same type on a single chip.

Memory 806 and persistent storage 808 are examples of storage devices 816. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 816 may also be referred to as computer readable storage devices in these illustrative examples. Memory 806, in these examples, can be, for example, a random-access memory or any other suitable volatile or non-volatile storage device. Persistent storage 808 may take various forms, depending on the particular implementation.

For example, persistent storage 808 may contain one or more components or devices. For example, persistent storage 808 can be a hard drive, a solid-state drive (SSD), a flash memory, a rewritable optical disk, a rewritable magnetic tape, or some combination of the above. The media used by persistent storage 808 also can be removable. For example, a removable hard drive can be used for persistent storage 808.

Communications unit 810, in these illustrative examples, provides for communications with other data processing systems or devices. In these illustrative examples, communications unit 810 is a network interface card.

Input/output unit 812 allows for input and output of data with other devices that can be connected to data processing system 800. For example, input/output unit 812 may provide a connection for user input through at least one of a keyboard, a mouse, or some other suitable input device. Further, input/output unit 812 may send output to a printer. Display 814 provides a mechanism to display information to a user.

Instructions for at least one of the operating system, applications, or programs can be located in storage devices 816, which are in communication with processor unit 804 through communications framework 802. The processes of the different embodiments can be performed by processor unit 804 using computer-implemented instructions, which may be located in a memory, such as memory 806.

These instructions are referred to as program instructions, computer usable program instructions, or computer readable program instructions that can be read and executed by a processor in processor unit 804. The program instructions in the different embodiments can be embodied on different physical or computer readable storage media, such as memory 806 or persistent storage 808.

Program instructions 818 are located in a functional form on computer readable media 820 that is selectively removable and can be loaded onto or transferred to data processing system 800 for execution by processor unit 804. Program instructions 818 and computer readable media 820 form computer program product 822 in these illustrative examples. In the illustrative example, computer readable media 820 is computer readable storage media 824.

Computer readable storage media 824 is a physical or tangible storage device used to store program instructions 818 rather than a medium that propagates or transmits program instructions 818. Computer readable storage media 824, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 818 can be transferred to data processing system 800 using a computer readable signal media. The computer readable signal media are signals and can be, for example, a propagated data signal containing program instructions 818. For example, the computer readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 820” can be singular or plural. For example, program instructions 818 can be located in computer readable media 820 in the form of a single storage device or system. In another example, program instructions 818 can be located in computer readable media 820 that is distributed in multiple data processing systems. In other words, some instructions in program instructions 818 can be located in one data processing system while other instructions in program instructions 818 can be located in one data processing system. For example, a portion of program instructions 818 can be located in computer readable media 820 in a server computer while another portion of program instructions 818 can be located in computer readable media 820 located in a set of client computers.

The different components illustrated for data processing system 800 are not meant to provide architectural limitations to the manner in which different embodiments can be implemented. In some illustrative examples, one or more of the components may be incorporated in or otherwise form a portion of, another component. For example, memory 806, or portions thereof, may be incorporated in processor unit 804 in some illustrative examples. The different illustrative embodiments can be implemented in a data processing system including components in addition to or in place of those illustrated for data processing system 800. Other components shown in FIG. 8 can be varied from the illustrative examples shown. The different embodiments can be implemented using any hardware device or system capable of running program instructions 818.

Thus, illustrative embodiments of the present invention provide a computer implemented method, computer system, and computer program product for estimating environmental impacts for an industrial asset. A number of processor units receive data for the industrial asset. The data for the industrial asset includes a number of variables associated with sustainability of the industrial asset. The sustainability of the industrial asset includes energy consumption, leakage, and energy loss associated with operations for the industrial asset. The number of processor units determines a relationship between environmental impact for the industrial asset and the number of variables according to the data. The number of processor units forecast energy consumption, leakage, and energy loss over a period of time for the industrial asset based on the data. The number of processor units estimate environmental impact for the industrial asset over the period of time based on the forecasted energy consumption, the forecasted energy loss, forecasted leakage, and the relationship.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes,” “including,” “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method, comprising:
receiving, by a number of processor units, data for an industrial asset, wherein the data for the industrial asset comprises a number of variables associated with sustainability of the industrial asset, and wherein the sustainability of the industrial asset comprises energy consumption, leakage, and energy loss associated with operations for the industrial asset;
determining, by the number of processor units, a relationship between environmental impact for the industrial asset and the number of variables according to the data;
forecasting, by the number of processor units, energy consumption, leakage, and energy loss over a period of time for the industrial asset based on the data; and
estimating, by the number of processor units, environmental impact for the industrial asset over the period of time based on the forecasted energy consumption, the forecasted energy loss, forecasted leakage, and the relationship.

2. A computer implemented method of claim 1, wherein the environmental impact for the industrial asset comprises at least one of noise pollution, air pollution, water pollution, environmental emission, solid wastes, radiation, or fire hazard.

3. A computer implemented method of claim 1, further comprising:
generating, by the number of process units, a multi-dimensional risk matrix based on estimated environmental emission, risk of failure, and criticality of industrial assets for the industrial asset.

4. A computer implemented method of claim 3, further comprising:
displaying, by the number of processor units, the multi-dimensional risk matrix, wherein each element in the multi-dimensional risk matrix comprises a number of industrial assets that correspond to a level of risk for the number of industrial assets based on estimated emission, risk of failure, and criticality for the number of industrial assets.

5. A computer implemented method of claim 1, further comprising:
determining, by the number of processor units, costs associated with the industrial asset based on estimated environmental impact for the industrial asset over the period of time.

6. A computer implemented method of claim 5, further comprising:
generating, by the number of processor units, an objective function to minimize costs associated with the industrial asset; and
generating, by the number of processor units, a management plan for the industrial asset using the objective function.

7. A computer implemented method of claim 6, wherein the management plan comprises at least one of replacing the industrial asset at a time point within the period of time or repairing the industrial asset at a time point within the period of time.

8. A computer system comprising:
a number of processor units, wherein the number of processor units executes program instructions to:
receive data for an industrial asset, wherein the data for the industrial asset comprises a number of variables associated with sustainability of the industrial asset, and wherein the sustainability of the industrial asset comprises energy consumption, leakage, and energy loss associated with operations for the industrial asset;
determine a relationship between environmental impact for the industrial asset and the number of variables according to the data;
forecast energy consumption, leakage, and energy loss over a period of time for the industrial asset based on the received data; and
estimate environmental impact for the industrial asset over the period of time based on the forecasted energy consumption, the forecasted energy loss, forecasted leakage, and the relationship.

9. The computer system of claim 8, wherein the environmental impact for the industrial asset comprises at least one of noise pollution, air pollution, water pollution, environmental emission, solid wastes, radiation, or fire hazard.

10. The computer system of claim 8, wherein the number of processor units further executes program instructions to:
generate a multi-dimensional risk matrix based on estimated environmental emission, risk of failure, and criticality of industrial assets for the industrial asset.

11. The computer system of claim 10, wherein the number of processor units further executes program instructions to:
display the multi-dimensional risk matrix, wherein each element in the multi-dimensional risk matrix comprises a number of industrial assets that correspond to a level of risk for the number of industrial assets based on estimated emission, risk of failure, and criticality for the number of industrial assets.

12. The computer system of claim 8, wherein the number of processor units further executes program instructions to:
determine costs associated with the industrial asset based on estimated environmental impact for the industrial asset over the period of time.

13. The computer system of claim 11, wherein the number of processor units further executes program instructions to:
generate an objective function to minimize costs associated with the industrial asset; and
generate a management plan for the industrial asset using the objective function.

14. The computer system of claim 13, wherein the management plan comprises at least one of replacing the industrial asset at a time point within the period of time or repairing the industrial asset at a time point within the period of time.

15. A computer program product for forecasting emission for an industrial asset, the computer program product comprising a computer readable storage medium having program instructions embodied therewith, the program instructions executable by a computer system to cause the computer system to:
receive data for an industrial asset, wherein the data for the industrial asset comprises a number of variables associated with sustainability of the industrial asset, and wherein the sustainability of the industrial asset comprises energy consumption, leakage, and energy loss associated with operations for the industrial asset;
determine a relationship between environmental impact for the industrial asset and the number of variables according to the data;
forecast energy consumption, leakage, and energy loss over a period of time for the industrial asset based on the received data; and
estimate environmental impact for the industrial asset over the period of time based on the forecasted energy consumption, the forecasted energy loss, forecasted leakage, and the relationship.

16. The computer program product of claim 15, wherein the environmental impact for the industrial asset comprises at least one of noise pollution, air pollution, water pollution, environmental emission, solid wastes, radiation, or fire hazard.

17. The computer program product of claim 16, wherein the number of processor units further executes program instructions to:
generate a multi-dimensional risk matrix based on estimated environmental emission, risk of failure, and criticality of industrial assets for the industrial asset.

18. The computer program product of claim 17, wherein the number of processor units further executes program instructions to:
display the multi-dimensional risk matrix, wherein each element in the multi-dimensional risk matrix comprises a number of industrial assets that correspond to a level of risk for the number of industrial assets based on estimated emission, risk of failure, and criticality for the number of industrial assets.

19. The computer program product of claim 17, wherein the number of processor units further executes program instructions to:
determine costs associated with the industrial asset based on the estimated environmental impact for the industrial asset over the period of time;
generate an objective function to minimize costs associated with the industrial asset; and
generate a management plan for the industrial asset using the objective function.

20. The computer program product of claim 19, wherein the management plan comprises at least one of replacing the industrial asset at a time point within the period of time or repairing the industrial asset at a time point within the period of time.
